(19) United States
(12) Patent Application Publication
(10) Pub. No.: US 2006/0267509 A1
(43) Pub. Date: Nov. 30, 2006

(54) Organic light emitting display and driving method thereof

(76) Inventor: Sun A. Yang, Suwon (KR)

Correspondence Address: CHRISTIE, PARKER & HALE, LLP, PO BOX 7068, PASADENA, CA, 91109-7068, US

(21) Appl. No.: 11/441,521

(22) Filed: May 26, 2006

(30) Foreign Application Priority Data
May 26, 2005 (KR) 2005-44696

(51) Int. Cl. G09G 3/10

(52) U.S. Cl. 315/169.3

(57) ABSTRACT

An organic light emitting display and a driving method for the display. Pixel circuits of the display, allow an increase in a data current in order to increase speed of charging the data current in a data line. Consequently, writing speed of data in the data line is higher with higher data current. The pixel circuit adjusts drive current passing through organic light emitting diodes to prevent an increase in the drive current due to the increased data current. The driving method divides non-emitting periods of the organic light emitting diode within one frame period. Therefore, the organic light emitting diode emits light at least twice within one frame period resulting in shorter non-emitting periods. Shortening the length of the non-emitting periods prevents flicker and image sticking even when the duty ratio or the overall duration of the emitting period remains constant.

### CROSS-REFERENCE TO RELATED APPLICATION

This application claims the benefit of Korean Patent Application No. 2005-44696, filed on May 26, 2005, in the Korean Intellectual Property Office, the entire content of which is incorporated herein by reference.

### FIELD OF THE INVENTION

The present invention relates to an organic light emitting display and a driving method for the display and, more particularly, to an organic light emitting display and a driving method, with improved data writing speed and reduced occurrence of flicker and image sticking.

### BACKGROUND

Various flat panel displays have been developed as substitutes for a Cathode Ray Tube (CRT) display that is relatively heavy and bulky. Flat panel displays include. Liquid Crystal Displays (LCDs), Field Emission Displays (FEDs), Plasma Display Panels (PDPs), Organic Light Emitting Displays, and the like.

An organic light emitting display among flat display devices includes an anode electrode, a cathode electrode, and an emission layer disposed between the anode and cathode electrodes. The organic light emitting display is an emissive display that generates light by recombination of electrons and holes in the emission layer. The organic light emitting display has advantages of high response speed and low power consumption when compared with other types of display devices, such as a liquid crystal display device, that require an additional light source.

FIG. 1 is a circuit diagram showing a conventional current drive pixel. The conventional current drive pixel includes an organic light emitting diode OLED and a pixel circuit. The pixel circuit includes first through fourth transistors T1, T2, T3, T4 and a capacitor C1. The first through fourth transistors T1, T2, T3, T4 each include a gate, a source, and a drain. The capacitor C1 includes a first electrode and a second electrode.

Current through the first transistor T1 is controlled by a data current Idata applied through the second transistor T2. The applied data current Idata is maintained for a predetermined time by the capacitor C1. The capacitor C1 is coupled between a source and a gate of the first transistor T1.

A scan line Sn is coupled to a gate of the second transistor T2 and a gate of the third transistor T3. A data line Dm is coupled to a source of the second transistor T2. A source and a drain of the third transistor T3 are coupled to a drain and the gate of the first transistor T1, respectively. A source of the fourth transistor T4 is coupled to a first power supply ELVdd, a drain of this transistor is coupled to the source of the first transistor T1, and a gate of the fourth transistor T4 is coupled to a light emitting control line En.

During operation, a scan signal sn applied to the gates of the second and third transistors T2, T3 goes to a low level in order to turn on the second and third transistors T2, T3 that are shown as PMOS field effect transistors in FIG. 1 and are turned on with a negative gate to source voltage. The first transistor T1 is diode-connected and a voltage corresponding to the data current Idata is stored in the capacitor C1.

When the scan signal sn changes to a high level to turn off the second and third transistors T2, T3, and a light emitting control signal en goes to a low level to turn on the fourth transistor T4, power is supplied from the first power supply ELVdd and an electric current corresponding to the voltage stored in the capacitor C1 flows from the first transistor T1 to the light emitting diode OLED causing it to emit light. The electric current flowing through the light emitting diode OLED I_{OLED} is expressed by equation 1.

$$Idata = \frac{β}{2} {( Vgs - \vert Vth \vert )}^{2} = {I}_{OLED} \qquad ( 1 )$$

where, Idata is the data current, Vgs is a voltage between the source and the gate of the first transistor T1, Vth is a threshold voltage of the first transistor T, I_{OLED} is the electronic current flowing through the light emitting diode OLED, and β is a gain factor of the first transistor T1.

As indicated in the equation 1, although the threshold voltage Vth and mobility of the first transistor T1 may not be uniform among different pixel circuits, the electric current I_{OLED} flowing through the light emitting diode OLED is identical with the data current Idata. Accordingly, when a write current source of a data driver, which supplies the data current Idata to the pixel circuits, remains uniform throughout the panel, uniform display properties may be obtained.

As described above, because a conventional current write type pixel circuit controls a minute current, it takes a long time to charge a capacitive load of the data line with the data current Idata. For example, assuming that the capacitive load of a data line is 30 pF, it takes several ms to charge the data line with an electric current ranging between several tens nA and several hundreds nA. Accordingly, a line time of several tens μs would not be sufficient for charging the capacitive load of the data line specially for low brightness where the data current Idata is small. The above discussion indicates that the conventional current write type pixel circuit requires a long charging time. Therefore, there is a need for a pixel circuit with a shorter charging time.

### SUMMARY OF THE INVENTION

Accordingly, it is an aspect of the present invention to provide an organic light emitting display and a driving method for the display that increase the data current in order to reduce the speed of charging the data current in a data line. Embodiments of the invention also divide a non-emitting period of an organic light emitting diode from one frame period in order to prevent occurrence of flicker and image sticking.

In one embodiment of the present invention an organic light emitting display is presented that includes a pixel portion having a plurality of pixels for displaying an image, a scan driver for providing a scan signal and a light emitting control signal to the pixel portion, and a data driver for providing a data current to the pixel portion. The pixels emit light corresponding to the data current selected by the scan signal during light emitting time periods that are separated by non-emitting periods that occur at least twice during one frame period. The light emitting periods and non-emitting periods occur according to the light emitting control signal. A drive current that is lower than the data current is used to drive the organic light emitting diodes.

According to one aspect of the present invention, an organic light emitting display is presented that includes a pixel portion having a plurality of pixels for displaying an image, a scan driver, and a data driver for providing a data current to the pixel portion. The scan driver is for providing a scan signal, a boosting signal, and a light emitting control signal to the pixel portion. The pixels that are selected by the scan signal, emit light in response to the light emitting control signal, during emitting periods that occur at least twice during one frame period. The organic light emitting diodes emit light corresponding to a drive current which is proportional to but lower than the data current provided by the data driver.

According to one aspect of the present invention, a method for driving an organic light emitting display including pixels that emit light corresponding to a drive current is presented. The method includes conducting a data current to the pixels and generating the drive current by the data current and conducting the drive current to an organic light emitting diode at least twice during one frame period causing the organic light emitting diode to emit light of a lower intensity than an intensity corresponding to the data current.

### BRIEF DESCRIPTION OF THE DRAWINGS

FIG. 1 is a circuit diagram showing a conventional current drive pixel.

FIG. 2 shows an organic light emitting display according to a first embodiment of the present invention.

FIG. 3 is a wave form chart showing the operation of a scan driver shown in FIG. 2.

FIG. 4 is a circuit diagram showing an example of a pixel used for the organic light emitting display of FIG. 2.

FIG. 5 is a circuit diagram showing another example of a pixel used for the organic light emitting display of FIG. 2.

FIG. 6 shows an organic light emitting display according to a second embodiment of the present invention.

FIG. 7 is a wave form chart showing the operation of a scan driver shown in FIG. 6.

FIG. 8 is a circuit diagram showing an example of a pixel used for the organic light emitting display of FIG. 6.

FIG. 9 is a circuit diagram showing another example of a pixel used for the organic light emitting display of FIG. 6.

FIG. 10 shows an organic light emitting display according to a third embodiment of the present invention.

FIG. 11 is a graph showing flicker of the organic light emitting display confirmed by sight.

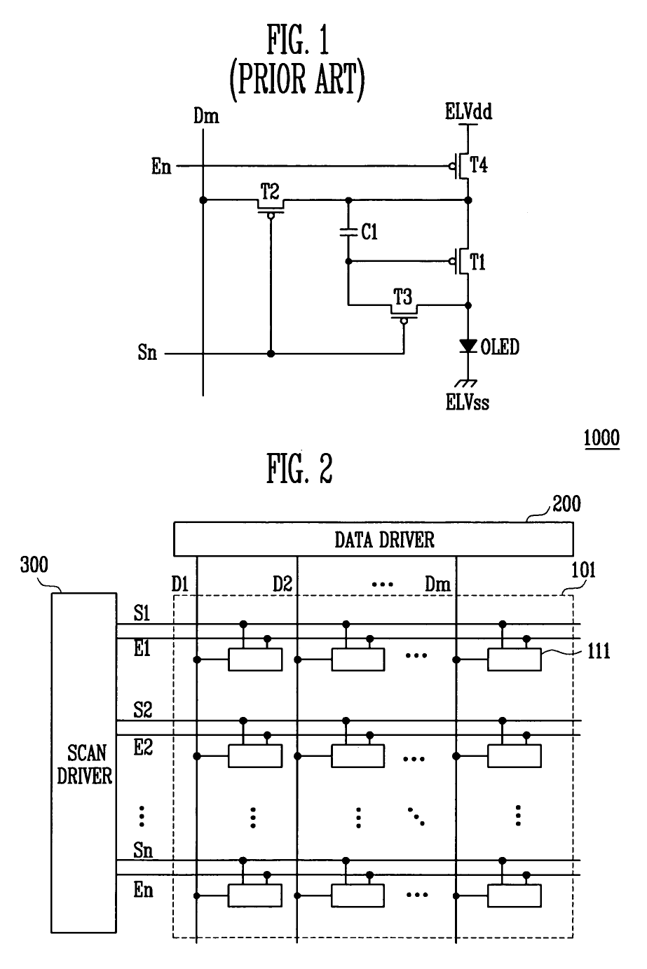

### DETAILED DESCRIPTION

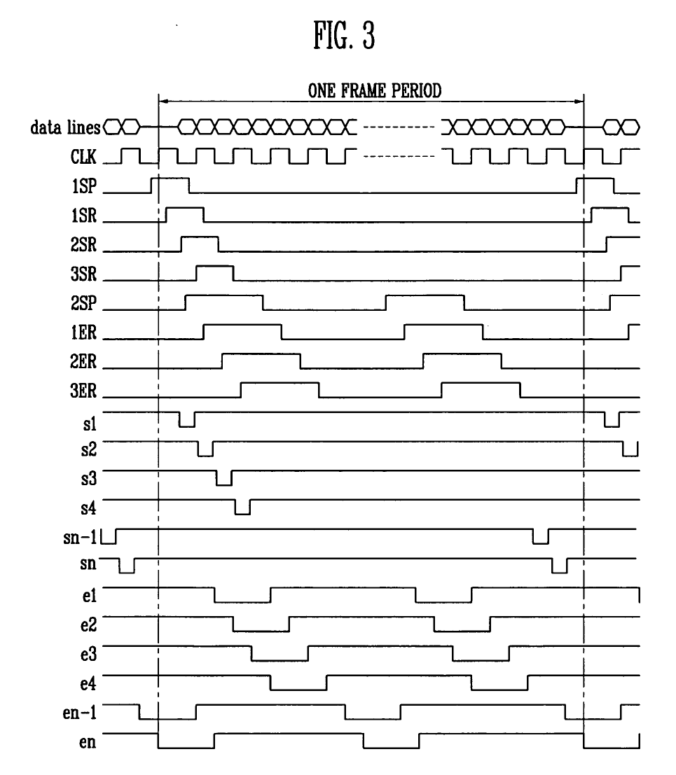

FIG. 2 shows an organic light emitting display 1000 according to a first embodiment of the present invention. The first embodiment of the organic light emitting display 1000 includes a pixel portion 101, a data driver 200, and a scan driver 300. The pixel portion 101 forms an image. The data driver 200 provides a data current. The scan driver 300 provides a scan signal.

The pixel portion 101 includes a plurality of pixels 111 each including a light emitting diode and a pixel circuit, a plurality of scan lines S1, S2 . . . Sn-1, Sn arranged in a column direction, a plurality of data lines D1, D2 . . . Dm-1, Dm arranged in a row direction, a plurality of light emitting control lines E1, E2 . . . En-1, En arranged in a column direction, and a plurality of first power lines Vdd (not shown) for supplying power.

Furthermore, in the pixel portion 101, when the data current is conducted to the pixel 111 through the data lines D1, D2 . . . Dm-1, Dm by the scan signal from the scan lines S1, S2 . . . Sn-1, Sn, the pixel 111 generates a drive current corresponding to the data current. In response to a light emitting control signal conducted through the light emitting control lines E1, E2 . . . En-1, En, the drive current flows through the pixel 111 causing the pixel 111 to emit light.

The data driver 200 is coupled to the plurality of data lines D1, D2 . . . Dm-1, Dm and provides the data current to the pixels 111 through the data lines D1, D2 . . . Dm-1, Dm, causing the pixels 111 to generate the drive current corresponding to the data current. Moreover, the amount of the data current is boosted to a value greater than the current required for driving the pixels 111. The boosted data current being conducted through the data lines D1, D2 . . . Dm-1, Dm allows the data lines D1, D2 . . . Dm-1, Dm to be rapidly charged, thereby embodying a high speed data write.

The scan driver 300 is coupled to the pixel portion 101 through the scan lines S1, S2 . . . Sn-1, Sn and the light emitting control lines E1, E2 . . . En-1, En, and provides the scan signals and the light emitting control signals to the pixels 111.

The scan driver 300 provides the data current to a pixel 111 selected by the scan signal and causes the pixel 111 to emit light for a period of time determined by the drive current. The drive current is generated in the pixel 111 in response to the light emitting control signal. Consequently, the pixel 111 divides every one frame period into an emission period and a non-emission period. The brightness of the organic light emitting display is represented by this division during the one frame period.

As described above, in a case where the pixel 111 emits light once during one frame period, if a user senses the non-emission period, a flicker may be perceived. In addition, when the pixel 111 emits the light once during one frame period, the data signal input to the pixel 111 may stay longer than the predetermined required time. This leads to the occurrence of image sticking.

One frame is divided into emitting periods, when light is being emitted, and non-emitting periods. The pixel 111 emits light a plurality of times during one frame period according the light emitting control signal. This causes the non-emitting periods to occur also a plurality of times. This does not allow a user to sense the non-emitting periods. When the pixel 111 emits light for a short time, the maintaining time of the data in the pixel 111 is kept short to prevent image flickering from occurring.

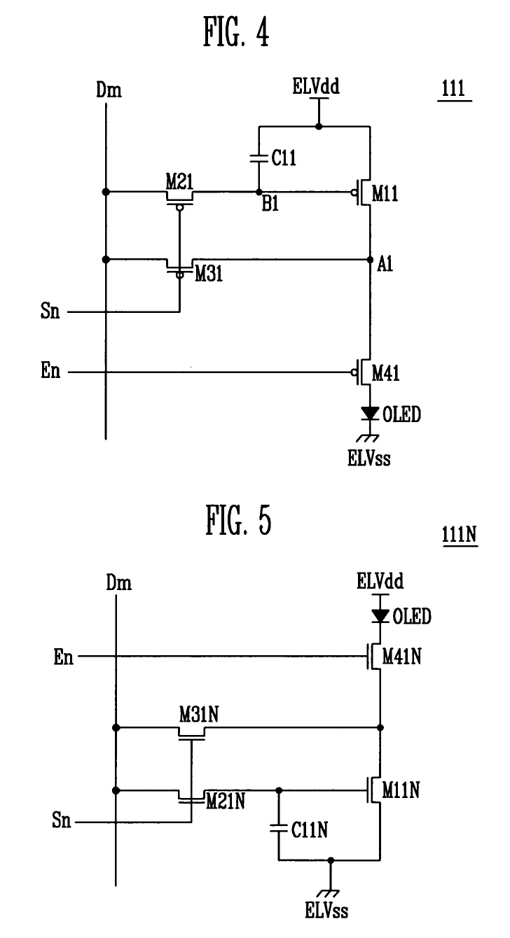

FIG. 3 is a wave form chart showing the operation of the scan driver 300 of the first embodiment of the organic light emitting display 1000 shown in FIG. 2. With reference to FIG. 3, the scan driver 300 includes a scan signal generator for generating a scan signal and a light emitting control signal generator for generating a light emitting control signal. The scan driver 300 receives a first start signal 1SP, a second start signal 2SP, and a clock signal CLK, and generates and provides the scan signal and the light emitting control signal to the pixel portion 101.

The scan signal generator includes a shift register. When the first start signal 1SP is input to the scan signal generator, it outputs a first scan shift signal 1SR obtained by shifting the first start signal 1SP. Also, the scan signal generator outputs a second scan shift signal 2SR using the first scan shift signal 1SR, and a third scan shift signal 3SR using the second scan shift signal 2SR. By repeating the aforementioned operation, n scan shift signals are sequentially generated and output. A first scan signal s1 is generated by logically combining the first start signal 1SP and the first scan shift signal 1SR. A second scan signal s2 is output by logically combining the first scan shift signal 1SR and the second scan shift signal 2SR. By logically combing the second scan shift signal 2SR and third scan shift signal 3SR, a third scan signal s3 is output. Through repeating the above mentioned operation, the scan signal generator generates n scan signals s1 . . . sn. Because the scan shift signals are sequentially generated, the corresponding n scan signals are also sequentially generated.

The light emitting control signal generator also includes a shift register. When the second start signal 2SP is input to the light emitting control signal generator, it outputs a first light emitting control shift signal 1ER obtained by shifting the second start signal 2SP. Furthermore, the light emitting control signal generator outputs a second light emitting control shift signal 2ER using the first light emitting control shift signal 1ER. In addition, the light emitting control signal generator outputs a third light emitting control shift signal 3ER using the second light emitting control shift signal 2ER. By repeating this operation, n light emitting control shift signals are sequentially generated and output. Furthermore, the second start signal 2SP and the first light emitting control shift signal 1ER are logically combined to generate a first light emitting control signal e1, the first light emitting control shift signal 1ER and the second light emitting control shift signal 2ER are logically combined to output a second light emitting control signal e2. Moreover, the second light emitting control shift signal 2ER and the third light emitting control shift signal 3ER are logically combined to output a third light emitting control signal e3. Through repeating this operation, n light emitting control signals are generated. Because the light emitting control shift signals are sequentially generated, the corresponding n light emitting control signals are also sequentially generated.

In the embodiment shown, a second start signal 2SP includes two pulses within one frame period, so that the first light emitting control shift signal 1ER also includes two pulses within the one frame period. Operation of the shift register causes each light emitting control shift signal to include two pulses. However, the second start signal 2SP may include more pluses than two, in which case the light emitting control signal would also include more pulses than two.

During generation period of a pulse in the light emitting control signal, a drive current flows to a pixel 111 that causes the pixel 111 to emit light. During a non-generation period of the pulse, the drive current does not flow to the pixel 111 and the pixel 111 does not emit light. Consequently, during one frame period, because emitting periods and non-emitting periods of the pixel 111 alternate, the non-emitting periods of the pixel 111 occur for a short period. As a result, a user cannot sense the non-emitting periods of the pixel 111, thereby preventing a flicker from occurring.

FIG. 4 is a circuit diagram showing a first example of the pixel 111 used for the organic light emitting display 1000 of FIG. 2. The pixel 111 of FIG. 4 includes an organic light emitting diode OLED and a pixel circuit. The pixel circuit includes first to fourth transistors M11, M21, M31, M41 and a capacitor C11. Each of the first to fourth transistors includes a source, a drain, and a gate. The capacitor C11 includes a first electrode and a second electrode.

Each of the first to fourth transistors M11, M21, M31, M41 is embodied by a PMOS transistor. Because the source and the drain of each transistor have the same properties, they may be called a first electrode and a second electrode, respectively.

A source of the first transistor M11 is coupled with a pixel power supply, a drain of this transistor is coupled with a first node A1, and its gate is coupled with a second node B1. The first transistor M11 conducts a drive current from the source to a drain side in response to a voltage of the second node B1.

A source of the second transistor M21 is coupled with a data line Dm, a drain of this transistor is coupled with the second node B1, and its gate is coupled with a scan line Sn. The second transistor M21 conducts a data current to the second node B1 in response to a scan signal being conducted through the scan line Sn.

A source of the third transistor M31 is coupled with the data line Dm, a drain of this transistor is coupled with the first node A1, and its gate is coupled with the scan line Sn. The third transistor M31 conducts the data current to the first node A1 in response to a scan signal conducted through the scan line Sn.

The second transistor M21 and the third transistor M31 maintain the same state in response to the scan signal. When the second transistor M21 and the third transistor M31 are turned on, the source and the drain of the first transistor M11 have the same voltage causing the first transistor M11 to be diode-connected.

A source of the fourth transistor M41 is coupled with the first node A1, a drain of this transistor is coupled with the organic light emitting diode OLED, and its gate is coupled with a light emitting control line En. The fourth transistor M41 conducts the drive current flowing through the first transistor M11 to the organic light emitting diode OLED in response to a light emitting control signal conducted through the light emitting control line En. In response to a light emitting control signal to control the fourth transistor M41, the fourth transistor M41 repeats a switching operation to control a light emitting time of the organic light emitting diode OLED.

Operation of the pixel is described by reference to FIG. 3. The pixel operates in response to the scan signal sn, the data current, and a light emitting control signal en.

When the scan signal sn goes to a low level, both of the second transistor M21 and the third transistor M31 are turned on causing the first transistor M11 to be diode-connected. Accordingly, a drive current corresponding to a data current flows from the source to the drain of the first transistor M11. Based on the previously presented equation 1, a voltage between the source and the gate of the first transistor M11 is expressed by a following equation 2.

$$\begin{matrix}Idata = \frac{β}{2} {( Vgs - \vert Vth \vert )}^{2} & ( 1 ) \\ Vgs = \sqrt{\frac{2 Idata}{β}} + Vth & ( 2 )\end{matrix}$$

where, Idata is an applied data current, Vgs is a voltage between the gate and the source of the first transistor M11, Vth is a threshold voltage of the first transistor M11, and β is a gain factor of the first transistor M11.

Furthermore, when the scan signal sn changes to a high level, and the second transistor M21 and the third transistor M31 are turned off, the capacitor C11 maintains the voltage at the source and the gate of the first transistor M11 constant. Moreover, when the light emitting control signal en changes to a low level to turn on the fourth transistor M41, a drive current flowing through the first transistor M11 flows into the organic light emitting diode OLED through the fourth transistor M41, thus causing the organic light emitting diode OLED to emit light.

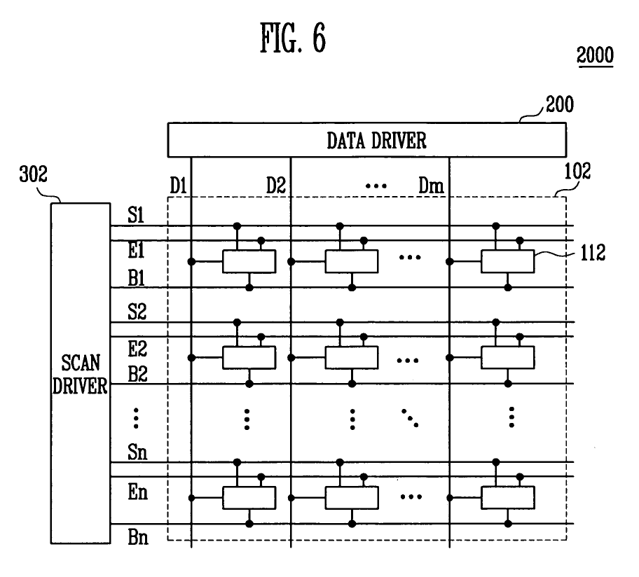

Also, as shown in FIG. 5, the pixel may be embodied by NMOS transistors. In that case, inverted signals of the wave form of FIG. 3 are used as inputs to the pixel 111N.

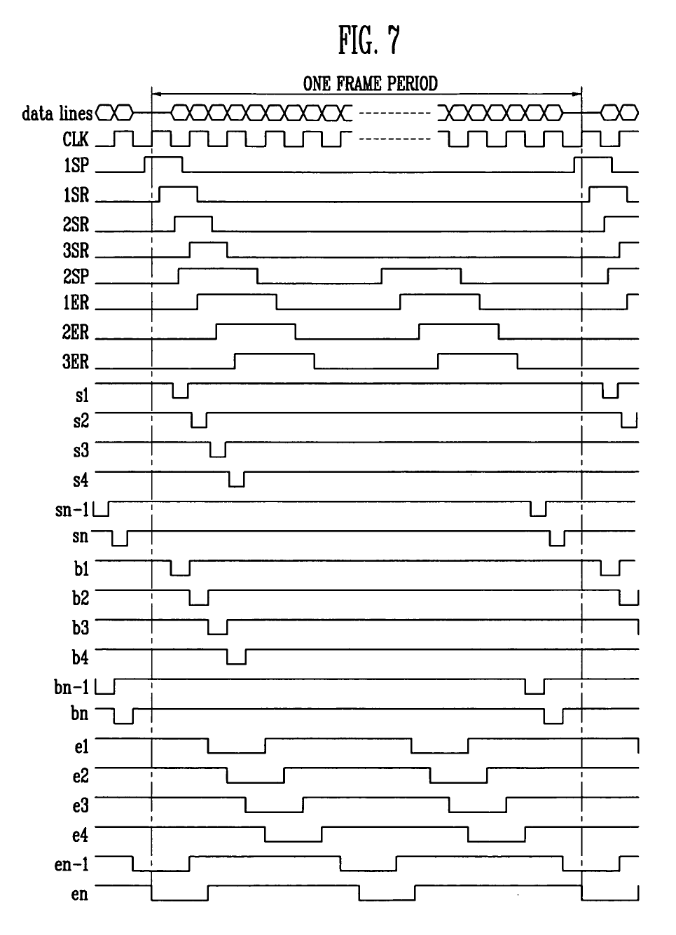

FIG. 6 shows an organic light emitting display 2000 according to a second embodiment of the present invention. This organic light emitting display 2000 includes a pixel portion 102, a data driver 200, and a scan driver 302. The pixel portion 102 forms the image to be presented. The data driver 200 provides a data current. The scan driver 302 provides a scan signal.

The pixel portion 102 includes a plurality of pixels 112 each including a light emitting diode and a pixel circuit, a plurality of scan lines S1, S2 . . . Sn-1, Sn arranged in a column direction, a plurality of data lines D1, D2 . . . Dm-1, Dm arranged in a row direction, a plurality of light emitting control lines E1, E2 . . . En-1, En arranged in a column direction, and a plurality of first power lines Vdd (not shown) for supplying a pixel with power.

Furthermore, in the pixel portion 102, when the data current is conducted to the pixel 112 through the data lines D1, D2 . . . Dm-1, Dm in response to the scan signal from the scan lines S1, S2 . . . Sn-1, Sn the pixel 112 generates a drive current corresponding to the data current. In response to a light emitting control signal conducted through the light emitting control lines E1, E2 . . . En-1, En the drive current flows through the pixel 112 to cause the pixel 112 to emit light.

The data driver 200 is coupled to the plurality of data lines D1, D2 . . . Dm-1, Dm and conducts the data current to the pixels 112 through the data lines D1, D2 . . . Dm-1, Dm so that the pixels 112 generate a drive current corresponding to the data current. The amount of the data current is boosted to be greater than that of the drive current. The boosted data current is conducted to the data lines D1, D2 . . . Dm-1, Dm so that the data lines D1, D2 . . . Dm-1, Dm are rapidly charged, thereby embodying a data write of a high speed.

The scan driver 302 is coupled to the pixel portion 102 through the scan lines S1, S2 . . . Sn-1, Sn and the light emitting control lines E1, E2 . . . En-1, En, and conducts the scan signal and the light emitting control signal to the pixels 112.

The scan driver 302 provides the data current to a pre-determined pixel 112 in response to the scan signal, and causes the selected pixel 112 to emit light corresponding to the drive current generated in the pixel 112 in response to the light emitting control signal. Consequently, the pixel 112 divides one frame period into an emission period and a non-emission period, thereby causing brightness of the organic light emitting display to be represented during the one frame period.

As described above, in a case where the pixel 112 emits light once during one frame period, a user senses the non-emission period as a flicker.

One frame is divided into emitting periods and non-emitting periods. Accordingly, the pixel 112 emits light a plurality of times during one frame period according to the light emitting control signal. This causes the non-emitting periods to be displayed a plurality of times but for short periods, so that a user cannot sense the non-emitting periods.

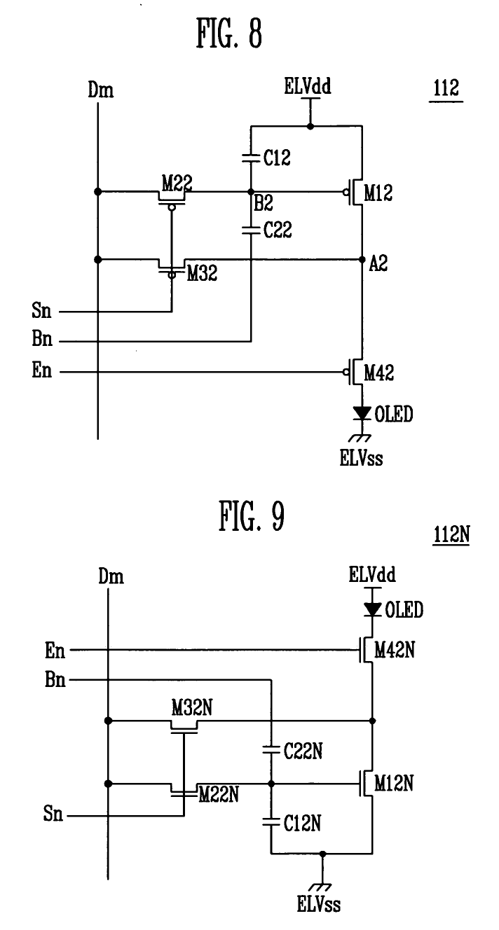

FIG. 7 is a wave form chart showing the operation of the scan driver 302 shown in FIG. 6. The scan driver 302 includes a scan signal generator for generating a scan signal and a light emitting control signal generator for generating a light emitting control signal. The scan driver 302 receives a first start signal 1SP, a second start signal 2SP, and a clock signal CLK, and generates and provides the scan signal, the light emitting control signal, and a boosting signal to the pixel portion 102.

The scan signal generator includes a shift register. When the first start signal 1SP is input to the scan signal generator, the scan signal generator outputs a first scan shift signal 1SR obtained by shifting the first start signal 1SP. Furthermore, the scan signal generator outputs the second scan shift signal 2SR using the first scan shift signal 1SR, and outputs a third scan shift signal 3SR using the second scan shift signal 2SR. By repeating this operation, n scan shift signals are sequentially generated and output. A first scan signal s1 is generated by logically combining the first start signal 1SP and the first scan shift signal 1SR. A second scan signal s2 is output by logically combining the first scan shift signal 1SR and the second scan shift signal 2SR. By logically combing the second scan shift signal 2SR and third scan shift signal 3SR, a third scan signal s3 is output. Through repetition of the above operation, the scan signal generator generates n scan signals. Because the scan shift signals are sequentially generated, the corresponding n scan signals are also sequentially generated.

The light emitting control signal generator also includes a shift register. When the second start signal 2SP is input to the light emitting scan signal generator, it outputs the first light emitting shift signal obtained by shifting the second start signal 2SP. The light emitting control signal generator outputs a second light emitting control shift signal 2ER using the first light emitting control shift signal 1ER. Further, the light emitting control signal generator outputs a third light emitting control shift signal 3ER using the second light emitting control shift signal 2ER. By repeating this operation, n light emitting control shift signals are sequentially generated and output. The second start signal 2SP and the first light emitting control shift signal are logically combined to generate a first light emitting control signal e1. The first light emitting control shift signal 1ER and the second light emitting control shift signal 2ER are logically combined to output a second light emitting control signal e2. Similarly, the second light emitting control shift signal 2ER and the third light emitting control shift signal 3ER are logically combined to output a third light emitting control signal e3. Through repeating this operation, n light emitting control signals are generated. Because the light emitting control shift signals are sequentially generated, the corresponding n light emitting control signals are also sequentially generated.

In addition, a second start signal 2SP is embodied by two pulses, so that the first light emitting control shift signal 1ER is embodied by two pulses. Operation of the shift register causes each light emitting control shift signal to be embodied by two pulses. However, the second start signal 2SP may be embodied by more pluses than two, in which case the corresponding light emitting control signal would include more than two pulses.

Further, the scan driver 302 generates and provides the boosting signal to the pixel through a boosting line Bn.

FIG. 8 is a circuit diagram showing an example of the pixel 112 used for the second embodiment of the organic light emitting display 2000 shown in FIG. 6. Referring to FIG. 8, the pixel 112 includes an organic light emitting diode OLED and a pixel circuit. The pixel circuit includes first to fourth transistors M12, M22, M32, M42, a first capacitor C12, and a second capacitor C22. Each of the first to fourth transistors includes a source, a drain, and a gate. The first capacitor C12 and the second capacitor C22 each include a first electrode and a second electrode.

In the exemplary embodiment shown, each of the first to fourth transistors M12, M22, M32, M42 is embodied by a PMOS transistor. Because a source and a drain of each transistor have the same properties, they may be called a first electrode and a second electrode, respectively.

A source of the first transistor M12 is coupled with a pixel power supply, a drain thereof is coupled with a first node A2, and a gate thereof is coupled with a second node B2. The first transistor M12 conducts a drive current from its source to its drain in response to a voltage at the second node B2.

A source of the second transistor M22 is coupled with a data line Dm, a drain thereof is coupled with a second node B2, and a gate thereof is coupled with a scan line Sn. The second transistor M22 conducts a data current to the second node A2 in response to a scan signal conducted through the scan line Sn.

A source of the third transistor M32 is coupled with the first node A2, a drain thereof is coupled with the data line Dm, and a gate thereof is coupled with the scan line Sn. The third transistor M32 conducts a current flowing from its source to its drain in response to a scan signal conducted through the scan line Sn.

A first electrode of the first capacitor C12 is coupled to the pixel power supply ELVdd and a second electrode thereof is coupled to the second node B2. The first capacitor C12 maintains a voltage corresponding to the data signal for a predetermined time.

A first electrode of the second capacitor C22 is coupled to the second node B2 and a second electrode thereof is coupled to a boosting signal line Bn. The second capacitor C22 changes a gate voltage of the first transistor M12 according to the boosting signal, causing an electric current flowing from the source to the drain of the first transistor M12 to be reduced. Consequently, the drive current flowing into the organic light emitting diode OLED will be less than the data current. The pixel circuit 112 allows maximizing the data current without increasing the drive current. Maximizing the amplitude of the data current for charging the data lines allows the time for charging the data line to be shorter.

A source of the fourth transistor M42 is coupled with the first node A2, a drain thereof is coupled with the organic light emitting diode OLED, and a gate thereof is coupled with a light emitting control line En. The fourth transistor M42 conducts the drive current flowing from the first transistor M12, through the first node A2, to the organic light emitting diode OLED in response to a light emitting control signal conducted through the light emitting control line En.

Operation of the pixel 112 is described by reference to FIG. 7. The pixel 112 operates in response to the scan signal sn, the data current, the boosting signal bn, and the light emitting control signal en.

During a period when the light emitting control signal en has a high state, the boosting signal bn is low and the scan signal sn is also low.

When the scan signal sn changes to a low level, both of the second transistor M22 and the third transistor M32 are turned on causing the data current Idata to flow from the source to the drain of the first transistor M12 and causing the first transistor M12 to become diode-connected. A voltage between the gate and the source of the first transistor M12 is based on the formerly presented equation 1 and is expressed by a following equation 3.

$$\begin{matrix}Idata = \frac{β}{2} {( Vgs - \vert Vth \vert )}^{2} & ( 1 ) \\ Vgs = \sqrt{\frac{2 Idata}{β}} + Vth & ( 3 )\end{matrix}$$

where, Idata is an applied data current, Vgs is a voltage between the gate and the source of the first transistor M12, Vth is a threshold voltage of the first transistor M12, and β is a gain factor of the first transistor M12.

Furthermore, after the scan signal sn changes to a high level, and the second transistor M22 and the third transistor M32 are turned off, the light emitting control signal en changes to a low level to turn on the fourth transistor M42. When the fourth transistor M42 is turned on, an electric current flowing through the first transistor M12 flows into the organic light emitting diode OLED through the fourth transistor M42, thus causing the light emitting diode OLED to emit light.

In this case, when the second transistor M22 is turned off, the gate voltage of the first transistor M12 is increased by coupling of the first capacitor C12 to the second capacitor C22. The increased gate voltage of the first transistor M12 is expressed by a following equation 4.

$$Δ Vg = \frac{Δ Vselect \cdot C 2}{C 1 + C 2} \qquad ( 4 )$$

where, ΔVg is the amount by which the gate voltage of the first transistor M12 is increased by the coupling of the first capacitor C12 and the second capacitor C22, and ΔVselect is voltage amplitude of a selection signal.

In addition, the electric current flowing through the organic light emitting diode OLED is expressed by a following equation 5.

$${I}_{OLED} = \frac{β}{2} {( Vgs - Δ Vg - \vert Vth \vert )}^{2} \qquad ( 5 )$$

where, I_{OLED} is an electric current flowing through the organic light emitting diode, Vgs is a voltage between the gate and source of the first transistor M12 when the data current flows through the first transistor M12, ΔVg is the amount by which the gate voltage of the first transistor M12 is increased by the coupling of the first capacitor C12 and the second capacitor C22, Vth is a threshold voltage of the first transistor M12, and β is a gain factor of the first transistor M12. An increase in the voltage applied to the gate of the first transistor M12 causes the drive current to be reduced. This allows the pixel circuit to use a larger data current and to attain a higher speed for writing to the data line without increasing the drive current that passes through the organic light emitting diode OLED.

Also, as shown in FIG. 9, the pixel may be embodied by NMOS transistors. In that case, inverted signals of the wave form of FIG. 7 are used as inputs to the pixel 112N.

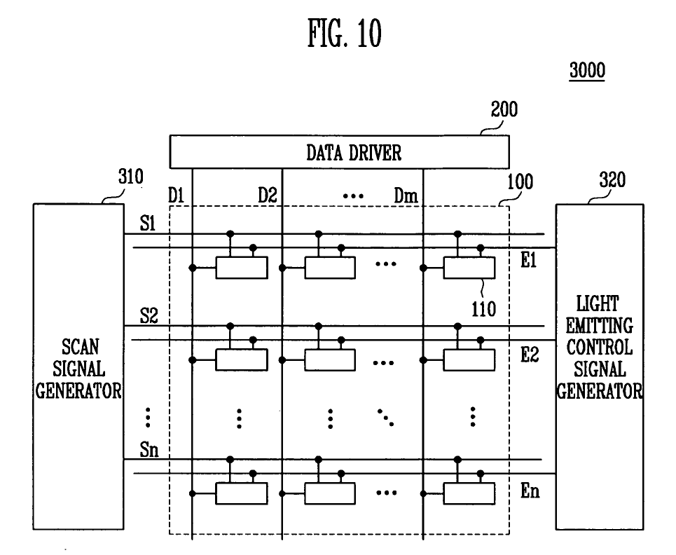

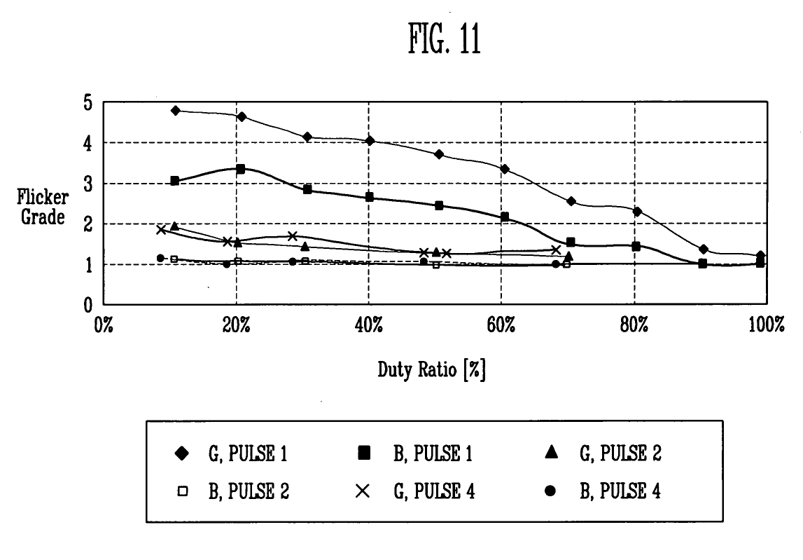

FIG. 10 shows an organic light emitting display 3000 according to a third embodiment of the present invention. A scan signal generator 310 of the scan driver is formed on one side of the pixel portion 100, a light emitting control signal generator 320 is formed on another side of the pixel portion 100, so that the organic light emitting display 3000 is symmetric.

When the scan signal generator 310 and the light emitting control signal generator 320 are formed within one scan driver, a dummy space is formed on a side opposite to the side where the scan driver is formed in order to form a symmetric organic light emitting display. As the scan signal generator 310 and the light emitting control signal generator 320 are formed within one scan driver, the size of the scan driver formed with be greater than the size of either of the scan signal generator 310 or the light emitting control signal generator 320. As a result, when the scan signal generator 310 is formed on one side of the pixel portion 100 and the light emitting control signal generator 320 is formed on the other side, the overall size of the organic light emitting display 3000 may be smaller.

FIG. 11 is a graph showing flicker grades for the organic light emitting displays of the invention. The grading of the flicker is done by sight. FIG. 11 shows flicker grades in green and blue parts of the images of the organic light emitting displays when the pixel portion emits light once, twice, and four times during one frame period. Table 1 shows a qualitative amount of flicker that each flicker grade shown on the vertical axis of FIG. 11 signifies.

TABLE 1

| 1 | 2 | 3 | 4 | 5 |
|---|---|---|---|---|
| No flicker | Small amount | Common | Large | Significant |
| | of flicker | amount of | amount of | amount of |
| | | flicker | flicker | flicker |

G or B notations in FIG. 11 indicate that the organic light emitting display represents only green or blue, respectively. Pulse 1 denotes light that is emitted only once during one frame period, Pulse 2 denotes light that is emitted twice during one frame period, and Pulse 4 denotes light that is emitted four times during one frame period. Duty Ratio, shown on the horizontal axis, represents a ratio between the emitting period and the non-emitting period during one frame period. For example, the Duty Ratio of 100% indicates that there is no non-emitting period during the frame and the entire frame period corresponds to the light-emitting period. As the Duty Ratio is reduced, the portion corresponding to the non-emitting period is increased. For example a Duty Ratio of 20% indicates that 20% of the frame period corresponds to the emitting period and 80% to the non-emitting period.

The graph of FIG. 11 indicates that when the Duty Ratio is low, flicker degree is high for Pulse 1 and low for Pulse 4. Consequently, for the same Duty Ratio, indicating the same overall duration of emitting period within one frame, the amount of flicker is reduced when the number of pulses are increased indicating that the emitting period is divided into more frequent but shorter emitting intervals.

In accordance with a light emitting display and a driving method for the display of the present invention, the light emitting period of the organic light emitting diode during one frame is adjusted to adjust the brightness of the organic light emitting display. In order to preserve the same brightness as that of light emitted during an entire one frame period, a larger current should be applied to the organic light emitting diode. As a result, the amount data current provided to the data line is increased resulting in a faster writing speed of data to the data line. In addition, during one frame period, the organic light emitting diode emits light in a manner to divide each non-emitting period into shorter intervals. A shorter non-emitting period prevents flicker and image sticking from occurring.

Although exemplary embodiments of the present invention have been shown and described, it would be appreciated by those skilled in the art that changes might be made to these embodiments without departing from the principles and spirit of the invention, the scope of which is defined in the claims and their equivalents.

What is claimed is:

1. An organic light emitting display comprising:
a pixel portion including a plurality of pixels for displaying an image;
a scan driver for providing a scan signal and a light emitting control signal to the pixel portion; and
a data driver for providing a data current to the pixel portion,
wherein the light emitting control signal controls at least two non-emitting periods to occur during one frame period, and a gradation to be substantially represented in the pixels is lower than a gradation of the data current.

2. The organic light emitting display as claimed in claim 1, wherein the scan driver includes:
a scan signal generator for generating the scan signal; and.
a light emitting control signal generator for generating the light emitting control signal.

3. The organic light emitting display as claimed in claim 2,
wherein the scan signal generator receives a first start signal, generates a first scan signal, and sequentially generates a plurality of scan signals related to the first scan signal, and
wherein the light emitting control signal generator receives a second start signal having a plurality of pulses, generates a first light emitting control signal having a plurality of pulses, and sequentially generates a plurality of light emitting control signals related to the first light emitting control signal.

4. The organic light emitting display as claimed in claim 2, wherein the scan signal generator is installed at one side surface of the pixel portion and the light emitting control signal generator is installed at another side of the pixel portion.

5. The organic light emitting display as claimed in claim 1, wherein each pixel of the plurality of pixels includes:
an organic light emitting diode for emitting light corresponding to a drive current;
a first transistor for conducting the drive current in response to a voltage applied to a gate of the first transistor;
a second transistor for selectively conducting the data current to the first transistor in response to the scan signal;
a third transistor for selectively diode-connecting the first transistor in response to the scan signal;
a fourth transistor for conducting the drive current to the organic light emitting diode in response to the light emitting control signal; and
a first capacitor for storing a first voltage corresponding to the data current.

6. The organic light emitting display as claimed in claim 5, wherein the fourth transistor selectively conducts the drive current to the organic light emitting diode at least twice during the one frame period.

7. An organic light emitting display comprising:
a pixel portion including a plurality of pixels for displaying an image;
a scan driver for providing a scan signal, a boosting signal, and a light emitting control signal to the pixel portion; and
a data driver for providing a data current to the pixel portion,
wherein pixels selected by the scan signal emit light during at least two light emitting periods in response to the light emitting control signal and a drive current lower than the data current, the at least two light emitting periods occurring during one frame period.

8. The organic light emitting display as claimed in claim 7, wherein the scan driver includes:
a scan signal generator for generating the scan signal; and
a light emitting control signal generator for generating the light emitting control signal.

9. The organic light emitting display as claimed in claim 8,
wherein the scan signal generator receives a first start signal, generates a first scan signal, and sequentially generates a plurality of scan signals in response to the first scan signal,
wherein the light emitting control signal generator receives a second start signal, generates a first light emitting control signal, and sequentially generates a plurality of light emitting control signals in response to the first light emitting control signal, and
wherein the second start signal and the plurality of light emitting control signals each include a plurality of pulses.

10. The organic light emitting display as claimed in claim 8, wherein the scan signal generator is installed at one side of the pixel portion and the light emitting control signal generator is installed at another side of the pixel portion.

11. The organic light emitting display as claimed in claim 7, wherein each pixel of the plurality of the pixels includes:
an organic light emitting diode;
a first transistor for conducting an electric current in response to a voltage applied to a gate of the first transistor;
a second transistor coupled between a data line from the data driver and a gate of the first transistor for selectively conducting the data current to the first transistor in response to the scan signal;
a third transistor coupled between the data line and the first transistor for conducting a data current to the first transistor in response to the scan signal;
a fourth transistor coupled between the first transistor and the organic light emitting diode for conducting a drive current to the organic light emitting diode in response to the light emitting control signal;
a first capacitor coupled between a power supply source and the gate of the first transistor for storing a first voltage corresponding to the data current; and
a second capacitor coupled in series to the first capacitor for changing a voltage stored in the first capacitor from the first voltage to a second voltage.

12. The organic light emitting display as claimed in claim 11, wherein the second voltage differs from the first voltage by an amount proportional to a booster voltage divided by the first and second capacitors when the boosting signal is being applied to the second capacitor.

13. The organic light emitting display as claimed in claim 11, wherein the fourth transistor maintains an on state in response to the light emitting control signal and selectively conducts the drive current to the organic light emitting diode at least twice during the one frame period.

14. A method for driving an organic light emitting display including pixels, the pixels emitting light corresponding to a drive current, the method comprising:
conducting a data current to the pixels and generating the drive current from the data current, the drive current being lower than the data current; and
conducting the drive current to an organic light emitting diode at least twice during one frame period.

15. The method of claim 14, wherein the pixels each include:
an organic light emitting diode for emitting light corresponding to the drive current;
a first transistor for conducting the drive current in response to a voltage applied to a gate of the first transistor;
a second transistor for selectively conducting the data current to the first transistor in response to a scan signal;
a third transistor for selectively diode-connecting the first transistor in response to the scan signal;
a fourth transistor for conducting the drive current to the organic light emitting diode in response to the light emitting control signal; and
a first capacitor for storing a first voltage corresponding to the data current.

16. The method of claim 14, wherein the pixels each include:
an organic light emitting diode;
a first transistor for conducting the drive current in response to a voltage applied to a gate of the first transistor;
a second transistor for selectively conducting the data current to the first transistor in response to a scan signal;
a third transistor for conducting the data current to the first transistor in response to the scan signal;
a fourth transistor for conducting the drive current to the organic light emitting diode in response to the light emitting control signal;
a first capacitor for storing a first voltage corresponding to the data current; and
a second capacitor coupled to the first capacitor in series for changing a voltage stored in the first capacitor from the first voltage to a second voltage.
